(19) United States
(12) Patent Application Publication
(10) Pub. No.: US 2006/0153002 A1
(43) Pub. Date: Jul. 13, 2006

(54) Jet Mixer With Adjustable Orifices

(75) Inventor: Peter James Ryan, League City, TX (US)

Correspondence Address: PETER J. RYAN, 2119 AUTUMN COVE DRIVE, LEAGUE CITY, TX, 77573, US

(73) Assignee: Mr. Peter James Ryan, League City, TX (US)

(21) Appl. No.: 10/905,555

(22) Filed: Jan. 10, 2005

(51) Int. Cl. B01F 5/04

(52) U.S. Cl. 366/162.4; 366/173.2

(57) ABSTRACT

A new and novel jet mixing device has been developed which can efficiently mix two or more miscible fluid streams together using high-shear hydraulic action and has both a turndown capacity which will allow the device to change the mixed product flow-rate without changing the composition of the mixed product and the capacity to maintain a constant mixed product flow-rate while varying the composition of the mixed product. A sleeve 12 with an identical orifice pattern as is found in the pipe section of the mixer 11 is moved in such a way—either in the axial or radial direction of the pipe section of the mixer—as to change the frequency of the opening of the orifices in the pipe section of the mixer. As the frequency of the opening of orifices in the pipe section of the mixer change, the amount of the secondary streams injected into the primary stream changes with respect to the flow-rate or composition of the primary stream.

### BACKGROUND

This invention relates to a jet mixing device that mixes two or more miscible fluid streams together and has the capability of increasing or decreasing the mixed product flow-rate while maintaining a constant mixture composition, or changing the mixture composition while maintaining a constant mixture flow-rate, by adjusting the opening frequency of the jet mixer injector orifices. The mixing of two or more miscible fluid streams is best accomplished using high-shear hydraulic forces. A jet mixer develops high-shear hydraulic forces by injecting one of the miscible fluid streams perpendicularly or tangentially into the flowing stream of the other flowing miscible fluid. The concept of a jet mixer is not novel; rather, this technology was first developed by Barber, et. al. in 1917 to mix miscible fluids. The Barber jet has been applied widely as a mixing device for combustion processes. Hunter and Nash (1933) described the operation of the Barber jet in detail. The jet-mixing technology has been further developed with the addition of mixing nozzles or orifices by Broderson and Bartels (1926) and Hunter (1938), and is described by Goldberger, et. al. (1973) and by Treybal (1951).

Jet mixers or jet pumps bring a primary stream and at least one secondary fluid stream together by flowing the primary stream axially through a section of pipe with one or more orifices in a specific pattern in the pipe section. A collar is fitted over the section of pipe with the orifices, and a nozzle is attached to the collar. A secondary stream is fed into the collar section of the jet mixer at a pressure higher than the pressure of the primary stream. As the secondary stream passes through the orifices in the pipe section of the mixer, it impinges on the primary stream flowing through the pipe section. The secondary stream is injected into the primary stream with enough force to allow the secondary stream to penetrate into the flowing primary stream. As the secondary stream penetrates into the primary stream, a high-shear mixing zone develops which ensures a very high degree of mixing between the primary and secondary streams.

Several references in the literature describe jet mixers with adjustable or self-adjusting orifices or injection points in the apparatus. Chisholm U.S. Pat. No. 4,125,331 discloses a mixing apparatus with an adjustable annular orifice. The vertical tube of the mixer is moved vertically up or down by attached pistons to increase or decrease the size of the orifice opening depending on the flow of dry bulk material entering the vertical tube.

Nedderman U.S. Pat. No. 5,758,691 discloses a self-sealing mixing valve which uses a hollow piston which slides axially along the centerline of the mixer allowing more of the secondary fluid to enter and mix with the primary fluid as the pressure of the secondary fluid increases. When the pressure of the secondary fluid is decreases, the spring-loaded piston seals against the downstream portion of the valve body.

Barns U.S. Pat. No. 6,192,911 discloses a venturi injector with a self-adjusting port. The annular gap between the inlet port body and the outlet port body is increased or decreases depending on the fluid pressure at the radial inlet port.

Allen U.S. Pat. No. 6,802,638 discloses an automatically adjusting annular jet mixer which uses a pressure regulator to maintain a constant pressure at the annular inlet orifice opening as the flow-rate of the primary guar powder is varied. In this manner, the specific mixing energy is maintained at a constant level.

Sunjewski U.S. Pat. No. 5,071,068 discloses an atomizer with a pattern of flow orifices in the duct section of the jet mixer designed to inject a secondary fluid tangentially into the flow of the primary fluid traveling through the duct.

Lott U.S. Pat. No. 5,322,222 discloses a spiral jet mixer with a pattern of angled inlet nozzles designed to inject a secondary fluid tangentially into the flow of the primary fluid traveling through the mixer. The inlet nozzles are removable, and may be replaced with inlet nozzles of varying orifice diameters to change the flow patterns in the jet mixer.

The jet mixer apparatuses described above can either be adjusted or are self-adjusting to maintain a specific flow-rate of the mixer product stream of a desired composition. The present invention describes a improvement of the jet mixer which has a turndown capability as well as a capacity to maintain a constant mixer product flow-rate while continuously varying the composition of the mixer product stream without stopping the operation of the jet mixer.

### SUMMARY

The invention, a jet mixer with adjustable orifices, is a new and novel jet mixer that can adjust the frequency of the orifice openings in the side of the mixer's pipe section, providing the jet mixer with both turndown capability and the capacity to change the composition of the mixed product stream while maintaining a constant mixed product flow-rate. The present jet mixer uses a sleeve fitted around the pipe section of the mixer with the orifice pattern drilled into the side. The sleeve has the identical pattern of orifices as is found drilled into the pipe section of the mixer. The sleeve is moved in such a manner as to open or close the orifices in the pipe section of the mixer depending on the amount of the secondary fluid stream required to produce a mixed product stream of constant composition or a constant flow-rate of mixed product stream with varying compositions. The mixed product stream flow-rate can be increased or decreased, and the orifices in the pipe section of the mixer will open and close faster or slower depending on the flow-rate and desired composition of the mixed product stream. Likewise, the mixed product stream flow-rate can be maintained at a constant flow-rate, and the orifices in the pipe section of the mixer will open and close faster or slower depending on the variation of the desired composition of the mixed product stream.

There are three embodiments of the invention. The first embodiment of the invention moves the sleeve back and forth in the axial direction of the pipe section of the mixer. In this embodiment of the invention, a spring is placed in contact with one end of the sleeve, and a cam is placed in contact with the other end of the sleeve. A drive shaft is attached to the cam and a drive motor is used to rotate the drive shaft. As the drive shaft is rotated, the cam forces the sleeve to move in the axial direction of the mixer pipe section until the apex of the cam meets the sleeve. Once the apex of the cam passes the contact point of the sleeve, the sleeve will be forced in the opposite direction by the spring expanding against the sleeve. As the flow-rate (or composition) of the mixed product stream changes, the speed of the motor rotating the drive shaft will change to maintain a constant composition (or flow-rate) of the mixed product stream. The frequency of the sleeve moving back and forth along the pipe section of the mixer will change the frequency of the openings of the orifices in the pipe section of the mixer, increasing or decreasing the amount of the secondary stream injected into the flowing primary stream.

The second embodiment of the invention again uses a sleeve with an identical orifice pattern as is found in the pipe section of the mixer to control the amount of the secondary stream injected into the flowing primary stream, but instead of moving the sleeve back and forth in the axial direction, the sleeve is moved back and forth in the radial direction of the pipe section of the mixer. In this embodiment of the invention a connecting arm is attached to one end of the sleeve. The sleeve arm is connected to the outer radial section of a drive wheel, which is connected to a drive motor. As the drive wheel rotates, the connecting arm attached to the sleeve causes the sleeve to move back and forth in the radial direction of the mixer pipe section. Changing the speed of the drive motor changes the frequency of the openings of the orifices in the pipe section, increasing or decreasing the amount of secondary fluid injected into the flowing primary fluid stream.

The third embodiment of the invention is the preferred embodiment of the invention. The third embodiment of the invention again uses a sleeve with an identical orifice pattern as is found in the pipe section of the mixer to control the amount of solute injected into the solvent stream, but instead of moving the sleeve back and forth in either the axial or radial direction, the sleeve is moved continuously in the radial direction around the pipe section of the mixer. This embodiment is a simplification of the invention since a cam and spring operation, or a connecting arm and drive wheel, is replaced with a gear attached to one end of the sleeve that is used to rotate the sleeve around the pipe section of the jet mixer. The frequency of the orifice openings is changed with respect to the flow-rate or desired composition of the mixed product by changing the speed of rotation of the drive motor, but now the sleeve is rotated continuously in the radial direction around the pipe section instead of back and forth in either the axial or radial direction of the pipe section.

### REFERENCES CITED

U.S. Patent Documents

| | | |
|---|---|---|
| 4,125,331 | 11/1978 | Chisholm |
| 5,071,068 | 12/1991 | Sunjewski |
| 5,322,222 | 6/1994 | Lott |
| 5,758,691 | 6/1998 | Nedderman |
| 6,192,911 | 2/2001 | Barnes |
| 6,802,638 | 10/2004 | Allen |

Broderson, H. J., and W. E. Bartels; U.S. Pat. No. 1,594,041 (Jul. 7, 1926).
Goldberger, W. M., et. al., “Chemical Engineer's Handbook”, R. H. Perry and C. H. Chilton, Ed., 5^{th} ed., pp. 21-4, -5, McGraw-Hill, New York (1973).
Hunter, T. G.; “Science of Petroleum”, A. E. Dunstan, Ed., Vol. 3, p. 1779, Oxford University Press (1938).
Hunter, T. G. and A. W. Nash; Ind. Chemist, 9 (1933)
Treybal, R. E.; “Liquid Extraction”. 1^{st} ed. pp. 268-270, McGraw-Hill, New York (1951).

### DRAWINGS

FIG. 1 is a drawing of the preferred embodiment of the invention with the sleeve fitted around the pipe section of the mixer. A gear, referred to as the sleeve gear, is attached to one end of the sleeve, and another gear is placed in contact with the sleeve gear. This gear is referred to as the drive gear. A drive shaft is attached to the drive gear, and as the drive gear is rotated, the sleeve is also rotated in the radial direction around the pipe section of the mixer.

FIG. 2 is a drawing of the sleeve with an identical orifice pattern as is found in the pipe section of the mixer.

### DETAILED DESCRIPTION OF DRAWINGS

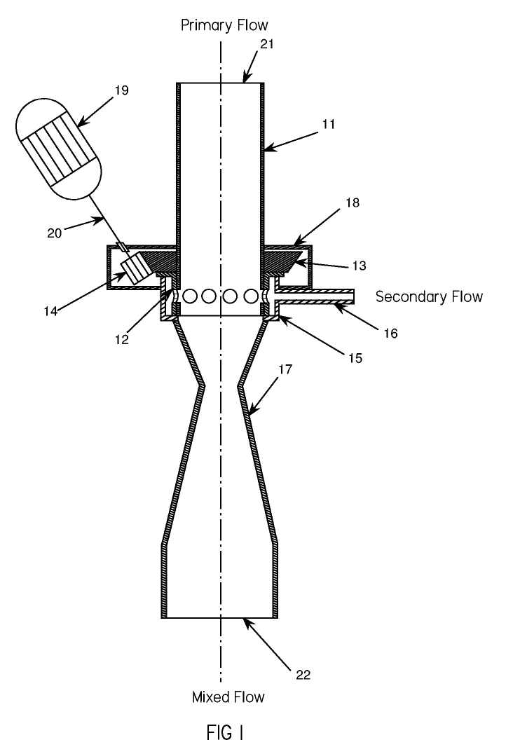

FIG. 1 is a drawing of the preferred embodiment of the invention. The sleeve with the identical orifice pattern 12 as is found in the pipe section of the mixer 11 is fitted around the pipe section of the mixer. The sleeve 12 has a gear 13 attached to one end of the sleeve 12. The gear 13 is referred to as the sleeve gear 13. A drive gear 14 is placed in contact with the sleeve gear 13, and a drive shaft 20 is attached to the drive gear 14. A motor 19 is attached to the drive shaft 20. As the drive shaft 20 is rotated, the drive gear 14 causes the sleeve gear 13 and the sleeve 12 to rotate in the radial direction around the pipe section of the mixer 11. As the rotational speed of the sleeve 12 is changed, the frequency of the openings of the orifices is changed with respect to the changes in the flow-rate or composition of the mixed product stream. The collar 15 has one or more nozzles 16 attached to it, through which one or more secondary streams are delivered to the mixing device. As the secondary streams are injected into the flowing primary stream, the secondary streams penetrate into the primary stream and develops a high-shear mixing zone.

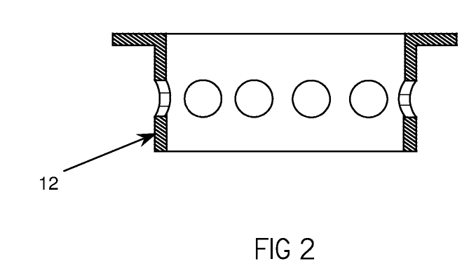

FIG. 2 shows the sleeve 12 that has an identical orifice pattern as is found in the pipe section of the mixer 11. The sleeve 12 is fitted around the pipe section of the mixer 11 and is used to change the frequency of opening of the orifices in the pipe section of the mixer.

### REFERENCE NUMERALS

11 pipe section of the mixer with orifices pattern
12 sleeve with an identical orifice pattern as is found in the pipe section of the mixer
13 sleeve gear
14 drive gear
15 collar which encloses the pipe section of the mixer with the orifice pattern
16 nozzle attached to the collar of the jet mixing device
17 discharge section of jet mixing device
18 sleeve gear and drive gear housing
19 drive motor
21 drive shaft
22 inlet of the jet mixing device
23 outlet of the jet mixing device
   Operation

In operation the frequency of the openings of the orifices in the pipe section of the mixer 11 is controlled by moving the sleeve with the identical orifice pattern 12 either back and forth in the axial or radial direction to the pipe section of the mixer (as described in the first and second embodiments of the invention) or in a continuous radial direction around the pipe section of the mixer 11 (as described in the preferred embodiment of the invention). The frequency of the openings of the orifices in the pipe section of the mixer 11 is changed with respect to changes in either the flow-rate or the desired composition of the mixed product stream. If the flow-rate of the mixed product stream increases, the frequency of the opening of the orifices in the pipe section of the mixer 11 will increase to allow more secondary fluid to penetrate into the flow of the primary stream and develop a high-shear mixing zone in the primary flow stream. Conversely, if the flow-rate of the mixed product stream decreases, the frequency of the opening of the orifices in the pipe section of the mixer will decrease to allow less secondary fluid to penetrate into the flow of the primary stream while still developing a high-shear mixing zone in the primary flow stream. In a similar manner, the composition of the mixed product stream can be changed while maintaining a constant mixed product flow-rate by changing the frequency of the hole openings in the pipe section of the mixer 11, thereby varying the amount of secondary fluid injected into the primary fluid stream.

What is claimed is:

1. A method for mixing two or more fluid streams using a jet mixer with adjustable orifices, comprising the steps of:
flowing a primary fluid stream through a pipe section with a specific pattern of orifices in the side of the pipe, and
attaching a sleeve with an identical pattern of orifices as is found in the pipe section of the mixer which covers the orifice pattern in the pipe section of the mixer and which can be moved in such a way as to open or close the orifices in the pipe section as the sleeve is moved, and
attaching a collar around the pipe section of the mixer which encloses the orifice pattern in the pipe section of the mixer as well as the sleeve with the identical pattern of orifices as well as the means which moves the sleeve to open or close the orifices in the pipe section, and
attaching one or more nozzles to the collar which will allow delivery of one or more secondary fluid streams into the collar at a higher pressure than the primary stream and thereby injecting the secondary streams into the flow of the primary fluid stream, and
attaching a drive mechanism to the sleeve which will move the sleeve in a back and forth direction either in the axial or radial direction of the pipe section of the mixer or continuously in the radial direction of the pipe section of the mixer,
whereby the injection of the secondary fluid streams into the primary fluid stream will cause hydraulic shear forces in the flow pattern of the primary fluid stream creating a high-shear mixing zone in the pipe section of the mixer, and
whereby the frequency of the motion of the sleeve will determine the amount of the secondary streams which are injected into the primary stream by changing the frequency of the opening of the orifices in the pipe section of the mixer and thereby providing the jet mixer with a turndown capacity, and
whereby said frequency of motion of the sleeve can be used to control the composition of the mixed stream exiting the mixer by changing the frequency of the opening of the orifices in the pipe section of the mixer.

2. The method of claim 1 in which a feed-back control system is used to hold the mixed product stream composition constant while the mixed product stream flow-rate is varied or to hold the mixed product flow-rate constant while the mixed product stream composition is varied,
whereby the feed-back control system monitors the flow-rate and composition of the mixed product stream and adjusts the frequency of the orifice openings in the pipe section of the mixer to maintain a set-point based on either the flow-rate or composition of the mixed product stream.

3. A jet mixer with adjustable orifices, comprising:
a pipe section with a specific pattern of orifices in the side of the pipe through which a primary fluid stream flows, and
a sleeve with an identical pattern of orifices as is found in the pipe section of the mixer which covers the orifice pattern in the pipe section of the mixer and which can be moved in such a way as to open or close the orifices in the pipe section as the sleeve is moved, and
a collar attached around the pipe section of the mixer and enclosing the orifice pattern in the pipe section of the mixer as well as the sleeve with the identical pattern of orifices as well as the means which moves the sleeve to open or close the orifices in the pipe section, and
one or more nozzles attached to the collar which will allow delivery of one or more secondary fluid streams into the collar at a higher pressure than the primary stream and thereby injecting the secondary streams into the flow of the primary fluid stream, and
a drive mechanism which is attached to the sleeve and which will move the sleeve in a back and forth direction either in the axial or radial direction of the pipe section of the mixer or continuously in the radial direction of the pipe section of the mixer,
whereby the injection of the secondary fluid streams into the primary fluid stream will cause hydraulic shear forces in the flow pattern of the primary fluid stream creating a high-shear mixing zone in the pipe section of the mixer, and
whereby the frequency of the motion of the sleeve will determine the amount of the secondary streams which are injected into the primary stream by changing the frequency of the opening of the orifices in the pipe section of the mixer and thereby providing the jet mixer with a turndown capacity, and
whereby said frequency of motion of the sleeve can be used to control the composition of the mixed stream exiting the mixer by changing the frequency of the opening of the orifices in the pipe section of the mixer.
